(19) United States
(12) Patent Application Publication
(10) Pub. No.: US 2017/0061814 A1
(43) Pub. Date: Mar. 2, 2017

(54) MOTIVATING A TARGET USER TO AID IN ACHIEVING A GOAL

(71) Applicant: International Business Machines Corporation, Armonk, NY (US)

(72) Inventors: JONATHAN T. COFFEY, BOSTON, MA (US); MARK DUFRESNE, NEW IPSWICH, NH (US); CHRISTOPHER D. JOHNSON, WESTFORD, MA (US); JAMES J. STADTMILLER, HUDSON, NH (US); RAZEYAH STEPHEN, MARLBORO, MA (US); YURIY VEYTSMAN, NEWTON, MA (US)

(73) Assignee: International Business Machines Corporation, Armonk, NY (US)

(21) Appl. No.: 14/834,801

(22) Filed: Aug. 25, 2015

(51) Int. Cl. G09B 19/00; G09B 5/02; H04L 12/58

(52) U.S. Cl. CPC G09B 19/00; H04L 51/32; G09B 5/02

(57) ABSTRACT

Motivating a target user to aid in achieving a goal includes identifying, from a social network, a target user capable of helping a primary user complete at least one step for achieving a goal, based on an analysis of a social graph from the primary user to the target user, forming a strategy, and based on the strategy, revising a request to create a revised request, the revised request motivating the target user to help the primary user complete the at least one step for achieving the goal.

### BACKGROUND

A social network is a network based application to enable a person to create a user account. Once the user account is created, the user establishes connections with other users, such as friends, family, and colleagues in an online environment. The users may then collaborate with each other on the social network by uploading pictures, sharing posts, sending messages, updating status information, and commenting on information posted by others, among other activities.

### BRIEF SUMMARY

A method for motivating a target user to aid in achieving the goal of a primary user includes identifying, from a social network, a target user capable of helping the primary user complete at least one step for achieving the goal. Then, based on an analysis of social connections from the primary user to the target user, the method includes forming a strategy, and based on the strategy, revising a request to create a revised request, the revised request motivating the target user to help the primary user complete the at least one step for achieving the goal.

A system for motivating a target user to aid in achieving a goal, the system includes a processor, computer program code, communicatively coupled to the processor, the computer program code includes an analyzing engine to analyze a request to determine steps for achieving a goal, an identifying engine to identify, from a social network, a target user capable of helping a primary user complete at least one of the steps for achieving the goal, a forming engine to, based on an analysis of a social graph of social connections including connections from the primary user to the target user, form a strategy, and a revising engine to, based on the strategy, revise the request to create a revised request, the revised request motivating the target user to help the primary user complete that step for achieving the goal.

A machine-readable storage medium encoded with instructions for motivating a target user to aid in achieving a goal, the instructions executable by a processor of a system to cause the system to, based on an analysis of a social graph from a primary user to a target user, form a strategy, and, based on the strategy, revise a request to create a revised request, the revised request motivating the target user to help the primary user complete at least one step for achieving a goal.

### BRIEF DESCRIPTION OF THE SEVERAL VIEWS OF THE DRAWINGS

The accompanying drawings illustrate various examples of the principles described herein and are a part of the specification. The examples do not limit the scope of the claims.

FIG. 1 is a diagram of an example of a system for motivating a target user to aid in achieving a goal, according to one example of principles described herein.

FIG. 2 is a diagram of an example of a system for motivating a target user to aid in achieving a goal, according to one example of principles described herein.

FIG. 3A is an example of a request that is revised to create a revised request in paragraph form, according to one example of principles described herein.

FIG. 3B is an example of a request that is revised to create a revised request in summary form, according to one example of principles described herein.

FIG. 4 is a flowchart of an example of a method for motivating a target user to aid in achieving a goal, according to one example of principles described herein.

FIG. 5 is a flowchart of an example of a method for motivating a target user to aid in achieving a goal, according to one example of principles described herein.

FIG. 6 is a diagram of an example of a motivating system, according to the principles described herein.

FIG. 7 is a diagram of an example of a motivating system, according to the principles described herein.

Throughout the drawings, identical reference numbers designate similar, but not necessarily identical, elements.

### DETAILED DESCRIPTION

The present specification describes a method and system for motivating a target user to aid a primary user in achieving a goal of the primary user the target user. The target user may be motivated to help by a request based on an analysis of social connections between the primary and target users. The request may also includes an explication of how helping the primary user is beneficial to the target user.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the target user's computer, partly on the target user's computer, as a stand-alone software package, partly on the target user's computer and partly on a remote computer or entirely on the remote computer or server. In the latter scenario, the remote computer may be connected to the target user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As noted above, once the target user account is created on a social network, the target user establishes connections with other users, such as friends, family, and colleagues in an online environment. Often, the target users collaborate via discussion groups, postings, and forums on the social network. The collaboration may take place between the target users to achieve a goal set by one of the target users. The goal may include resolving an issue, such as a defect with a product.

Often, a target user manually identifies the target users capable of helping them achieve a goal. However, once the target users are identified, it is difficult and time consuming for the target user to convince the other users that it is mutually beneficial for them to help achieve at least part of the goal. As a result, the target users may choose not to help the target user. This leads to the target user becoming frustrated and needing to convince other users to help them achieve the goal.

The principles described herein include a method for motivating a target user to aid in achieving a goal. Such a method includes identifying, from a social network, a target user capable of helping a primary user complete at least one step for achieving a goal, based on an analysis of social connections from the primary user to the target user or linking the primary user to the target user, forming a strategy, and based on the strategy, revising the request to create a revised request, the revised request motivating the target user to help the primary user complete that step for achieving the goal. Such a method provides a complete solution to motivate users to take a desired action by crafting a primary user's request for optimal response. As a result, the method enables users to connect and collaborate more efficiently.

In the present specification and in the appended claims, the term “user” means a member of a social network that is capable of helping a primary user complete a step for achieving a goal as presented in a request. The target user may be directly connected to the primary user. The target user may be indirectly connected to the primary user.

In the present specification and in the appended claims, the term “primary user” means a member of a social network that needs help achieving a goal. The primary user may create a request to another user of the social network requesting assistance with one or more steps the primary user needs to complete to achieve the goal.

In the present specification and in the appended claims, the term “strategy” means a mechanism used to motivate a target user to provide assistance to complete a step needed to achieve the primary user's goal. The strategy may identify how the target user benefits by aiding the primary user.

In the present specification and in the appended claims, the term “revised request” means a modification to a request, based on a strategy, to motivate the target user to complete a step needed to achieve the primary user's goal. The revised request may be presented to the target user in summary form or in paragraph form.

In the present specification and in the appended claims, the term “goal” means a desired result that a primary user envisions or commits to achieve. The goal may include any number of steps that need to be completed to achieve the goal. As indicated, a primary user may request the assistance of other users of a social network with one or more steps of a goal.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

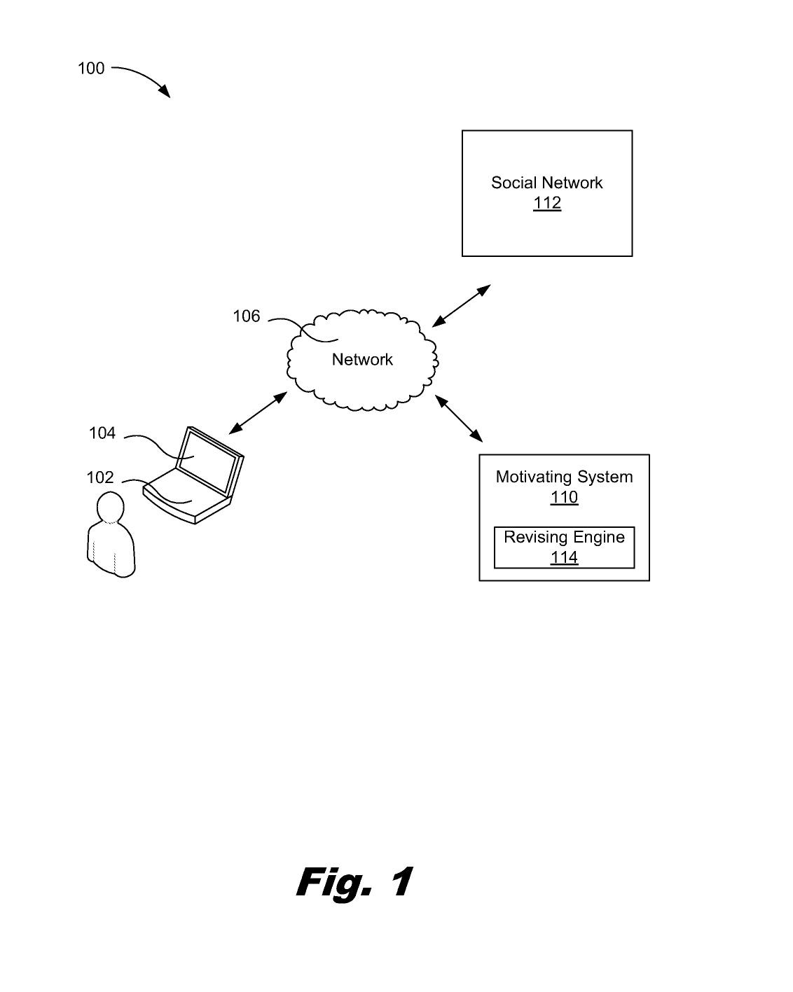

Referring now to the figures, FIG. 1 is a diagram of an example of a system for motivating a target user to aid in achieving a goal, according to one example of principles described herein. As will be described below, a motivating system is in communication with a network to identify, from a social network, a target user capable of helping a primary user complete at least one step for achieving a goal. Further, the motivating system may, based on an analysis of social connections between the primary user and the target user whose assistance is desired, form a strategy. The motivating system may, based on the strategy, revise the request to create a revised request, the revised request motivating the target user to help the primary user complete that step for achieving the goal.

As illustrated, the system (100) includes the social network (112). The social network (112) is a network based application to enable users to create a target user account. Thus the target users become members of the social network (112). Once the target user accounts are created, the target users establish connections with other users, such as friends, family, and colleagues in an online environment. Further, the target users may collaborate with each other on the social network (112) by uploading pictures, uploading a post, sending a message, updating status information, commenting on other user's information, initiating instant messages (IM), initiating a video chat, among other activities.

Further, the system (100) includes a target user device (102) with a display (104). A member, such as primary user, of the social network (112) uses the target user device to create a request. The request may define a number of steps that are needed to achieve a goal set by the primary user. Once the primary user creates a request, the request is sent to a motivating system (110) via a network (106).

The system (100) further includes the motivating system (110). The motivating system (110) may be in communication with the target user device (102) and the social network (112) over a network (106).

The motivating system (110) identifies, from the social network (112), a target user capable of helping the primary user complete at least one step for achieving a goal. The target user may be directly connected to the primary user. As a result, the primary user may communicate directly with the target user. Alternatively, the target user may be indirectly connected to the primary user. As a result, the primary user may communicate with the target user through another user or a manager of the target user, if needed.

The motivating system (110) further forms, based on an analysis of a social graph from the primary user to the target user, a strategy. As will be described in other parts of this specification, the strategy identifies how the request affects the target user, benefits for the target user, assets for exchange, a preferred communication, mutual benefits, or combinations thereof.

Further, the motivating system (110) revises, based on the strategy, the request to create a revised request, the revised request motivating the target user to help the primary user complete that step for achieving the goal. In an example, a revising engine (114) may, based on the strategy, revise the request to create the revised request. As will be described in other parts of this specification, the revised request is delivered to the target user via electronic mail (email), IM, short message service (SMS), a posting on a social network, or combinations thereof. Such a system (100) provides a complete solution to motivate users to take a desired action by crafting the primary user's request for optimal response. As a result, the system (100) enables a primary user to connect and collaborate with other users more efficiently. More information about the motivating system (110) will be described later on in this specification.

While this example has been described with reference to the motivating system being located over the network, the motivating system may be located in any appropriate location according to the principles described herein. For example, the motivating system may be located in a target user device, a social network, a server, a datacenter, other locations, or combinations thereof.

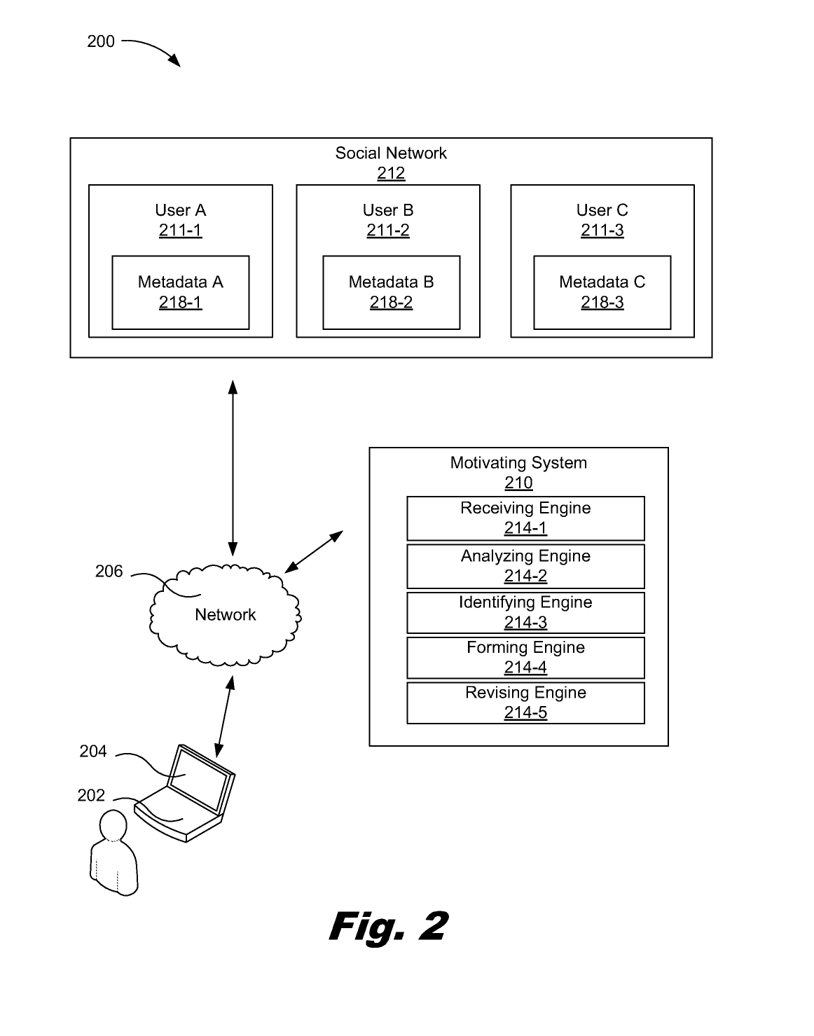

FIG. 2 is a diagram of an example of a system for motivating a target user to aid in achieving a goal, according to one example of principles described herein. As will be described below, a motivating system is in communication with a network to identify, from a social network, a target user capable of helping a primary user complete at least one step for achieving a goal. Further, the motivating system may, based on an analysis of a social graph from the primary user to the target user, form a strategy. The motivating system may, based on the strategy, revise the request to create a revised request, the revised request motivating the target user to help the primary user complete that step for achieving the goal.

In one example, the system (200) includes a target user device (202) with a display (202). As mentioned above, a primary user uses the target user device (202) to create a request. The request may be created via a graphical user interface (GUI) displayed on the display (204) of the target user device (202). The GUI may include text boxes or drop down boxes to allow the primary user to specify terms that describe steps related to achieving a goal. The goal may be a desired result that a primary user envisions or commits to achieve. The goal may include a number of steps that need to be completed to achieve the goal. As indicated, a primary user may request the assistance of other users of the social network (212) with one or more steps of a goal. Once the primary user creates the request, the request is sent to a motivating system (210) via a network (106). Further, the request may be intended for at least one user (211) of the social network (212). As will be described below, the request may be revised by the motivating system (210) to motivate a target user to aid the primary user in completing at least one step of the goal.

As illustrated, the system (200) includes the social network (212). The social network (212) may include a number of users (211). For example, the social network (212) may include user A (211-1), user B (211-2), and user C (211-3). Further, some or all of the target users (211) may aid the primary user in achieving the goal.

Further, each of the target users (211) may be associated with metadata (218). For example, user A (211-1) may be associated with metadata A (218-1). User B (211-2) may be associated with metadata B (218-2). User C (211-3) may be associated with metadata C (218-3). The metadata (218) may specify motivating factors for each of the target users (211), resources available to the target users (211), an expertise for each of the target users (211), a language that each of the target users (211) speaks, other metadata, or combinations thereof. For example, metadata A (218-1) may specify that user A (211-1) is motivated by a transfer of knowledge, has an expertise with product X, speaks English and Spanish, and has access to hardware resource X. Metadata B (218-2) may specify that user B (211-2) is motivated by sharing hardware resources, has an expertise with product Y, and speaks English. Further, metadata C (218-1) may specify that user C (211-3) is motivated by money, has an expertise with product X and product Y, and speaks Spanish. As a result, the metadata (218) may aid the motivating system (210) in identifying a target user (211) capable of helping a primary user achieve at least part of a goal. As will be described in other parts of this specification, the primary user may manually identify the target user.

The system (200) further includes a motivating system (210). In one example, the motivating system (210) includes a processor and computer program code. The computer program code is communicatively coupled to the processor. The computer program code includes a number of engines (214). The engines (214) refer to program instructions for performing a designated function. The computer program code causes the processor to execute the designated function of the engines (214). In other examples, the engines (214) refer to a combination of hardware and program instructions to perform a designated function. Each of the engines (214) may include a processor and memory. The program instructions are stored in the memory and cause the processor to execute the designated function of the engine. As illustrated, the motivating system (210) includes a receiving engine (214-1), an analyzing engine (214-2), an identifying engine (214-3), a forming engine (214-4), and a revising engine (214-5).

The receiving engine (214-1) receives, from a primary user, a request for achieving a goal. The request includes language defining the goal and at least one step for achieving the goal. The language may be used as a set of relevant search terms. The language may be specific to an issue form the viewpoint of the primary user. The language may be specific to the issue form the viewpoint of a target user. As will be described below, the language may be used to for determining the steps for achieving the goal.

The analyzing engine (214-2) analyzes the request to determine steps for achieving the goal. The steps may be language extracted from a request that specifies what is needed to achieve the goal. The steps may be related to business, financials, shared resources, mutual issue, or combinations thereof. For example, if the goal is to utilize two specific hardware resources, the steps may include utilizing hardware resource X and hardware resource Y.

The identifying engine (214-3) identifies, from the social network (212) and the information available about users on the social network, a target user capable of helping the primary user complete at least one step for achieving a goal. For example, if the request includes step such as utilizing hardware resource X, the identifying engine (214-3) may identify a target user with expertise in hardware resource X indicating that that user would be capable of helping the primary user for this step. In an example, user A (211-1) may be identified, based on a social network profile or base on metadata A (218-1), as a target user capable of helping the primary user complete this step.

In some examples, the target user (211) may be a target user that the primary user doesn't know, is unwilling to commit resources, is too busy to help the primary user, may not see how the issue affects them, doesn't understand the issue, doesn't speak the same language as the primary user, are blocked by hieratical or cultural restricts for directly speaking with the primary user, or combinations thereof. As a result, the identifying engine (214-3) may assess how well a target user communicates and collaborates with others. Further, the identifying engine (214-3) identifies if the target user is available to help the primary user. If the target user is unavailable, the identifying engine (214-3) may identify another user that is available to help the primary user.

The forming engine (214-4) may, based on an analysis of a social graph from the primary user to the target user, form a strategy. The strategy may be a mechanism used to motivate the target user to provide assistance to complete a step needed to achieve the primary user's goal. The social graph may be a representation of a set of objects, such as users, that are connected via links. As a result, the social graph may depict relationships of the primary user and the target users and connections, if any, between the two. The forming engine (214-4) may use social networking analysis tools to find the best path to the target user via the social graph.

In some examples, the strategy identifies how the request affects the target user. This may include: if resolution of the goal provides any benefit to the target user, if there are any legal consequences that may impede the target user from helping the primary user, other affects, or combinations thereof. Specifically, the strategy may identify how complying with the request benefits the target user, if it does. This may include, for example, how achieving the goal may aid in resolving an issue that the target user has, such as an issue with a product, monetary compensation, other benefits, or combinations thereof.

The strategy may identify assets for exchange. This may include sharing hardware resources, money, loaning of tools, a transfer of knowledge, other assets, or combinations thereof.

Further, the strategy may identify a preferred mode of communication between the target user and the primary user. This may include communicating via email, IM, SMS, face to face, over the phone, via video chat, other methods of communication, or combinations thereof.

The strategy may further identify mutual benefits. This may include solving a mutual problem, achieving a mutual goal, other mutual benefits, or combinations thereof.

Further, the strategy may include motivating factors. The motivating factors are weighted based on an impact of an outcome of the request. The weight of the motivating factors may be a range such as 0 to 10 where 10 indicates an important motivating factor and 0 represents an unimportant motivating factor. The weight of the motivating factors may be a symbolic such as low to high where high indicates an important motivating factor and low represents an unimportant motivating factor. The motivating factors may include what is important to the target user, meeting financial or sales targets for a department, knowledge transfer potential, opportunity to fix customer impact issues, other motivating factors, or combinations thereof. Further, the motivating factors may include what is important to the primary user. As a result, the motivating factors may be mapped to the goal and/or the steps associated with the goal.

The strategy may further include a list of assets that may be bartered. The assets may include knowledge transfer, physical assets such as hardware, or money.

The strategy may further include what is the common ground between the target user and the primary user. The common ground may include common terms. The common terms may be an indexed list of keywords that are ranked by relevance. The list of keywords may be ranked via sematic mapping, term clustering, category or summary translation. The common terms may be translated into another language based on language translation techniques.

The common ground may be proposed as a win-win situation. The win-win situation may be mutually beneficial arrangements.

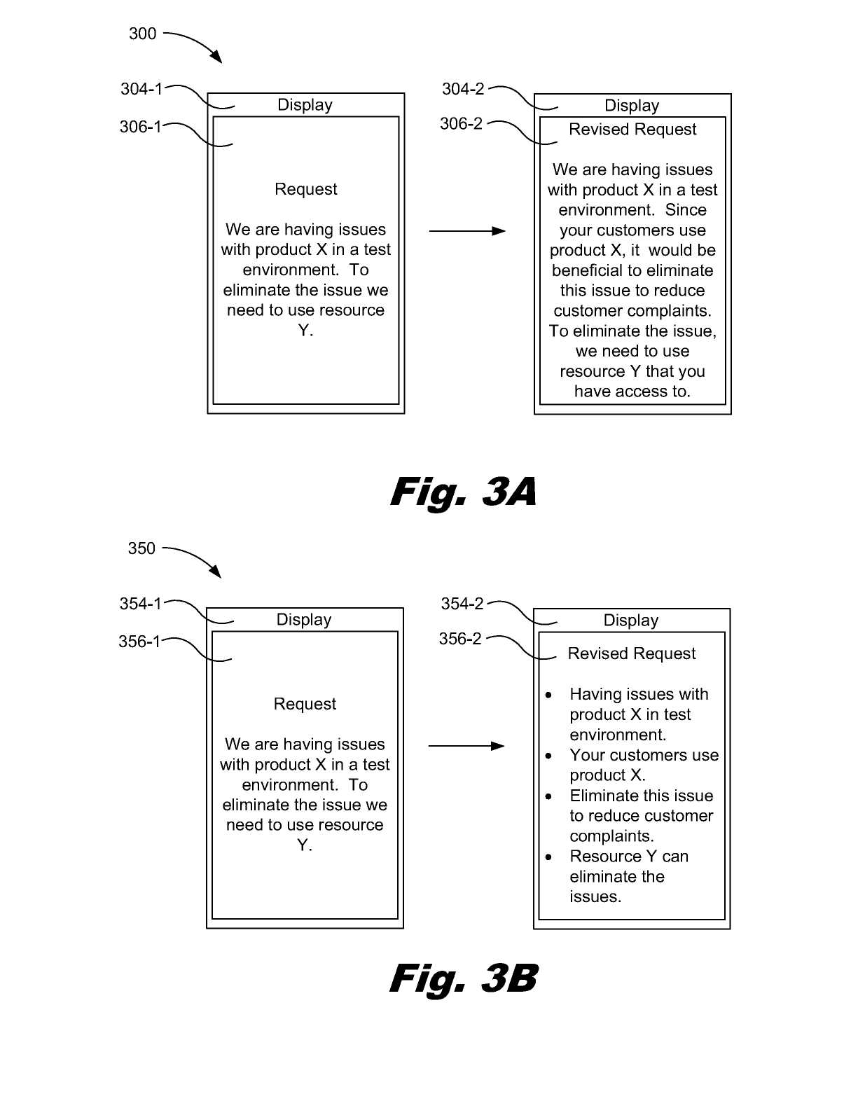

The revising engine (214-5) may, based on the strategy, revise the request to create a revised request, the revised request motivating the target user to help the primary user complete that step for achieving the goal. The revised request may include an explanation of the steps need to achieve the goal. Further, the revised request is crafted such that the target user is motivated to help the primary user complete at least one step of the goal. The revised request is delivered to the target user via email, IM, SMS, a posting on a social network, or combinations thereof. More information about the revised request will be described in FIGS. 3A and 3B.

In some examples, feedback may be sent to the motivating system (210). The feedback may include availability of a target user to choose a second user should the target user become unavailable. Further, the feedback may include positive or negative reviews about whether the revised request aided in motivating the target user or not. This may be used to improve future revised requests.

An overall example of FIG. 2 will now be described. The receiving engine (214-1) receives, from a primary user, a request for achieving a goal. The goal may include resolving issue X. The analyzing engine (214-2) analyzes the request to determine steps for achieving the goal. A step may include utilizing hardware resource X. The identifying engine (214-3) identifies, from the social network (212), user B (211-2) is capable of helping the primary user for this step. The forming engine (214-4) may, based on an analysis of a social graph from the primary user to user B (211-2), form a strategy. The strategy may include sharing hardware resources. The revising engine (214-5) may, based on the strategy, revise the request to create a revised request, the revised request is such that user B (211-2) is motivated to help the primary user achieve the goal.

While this example has been described with reference to the target users being identified from a social network, the target user may be identified from other system. The system may include an email system, a database, other systems, or combinations thereof.

FIG. 3A is an example of a request that is revised to create a revised request in paragraph form, according to one example of principles described herein. As will be described below, a request may be revised to create a revised request. The request may be presented to a target user in paragraph form.

As illustrated, the system includes a display (304-1). The display (304-1) may display a request (306-1) that is created by the primary user to another user of the social network requesting assistance with one or more steps the primary user needs to complete to achieve the goal. The request (306-1) may state that we are having issues with product X in a test environment. To eliminate the issue we need to use resource Y. In this example, the request is in English, includes the goal of eliminating issues with product X, and includes a step of needing to access resource Y.

As mentioned above, the motivating system may revise the request (306-1), based on a strategy, to motivate a target user to help the primary user complete the step such that the goal is achieved. As illustrated, the revised request (306-2) may be displayed via a display (304-2). In this example, the revised request (306-2) may be presented to the target user in paragraph form. As illustrated, the revised request (306-2) states, we are having issues with product X in a test environment. Since your customers use product X, it would be beneficial to eliminate the issue to reduce customer complains. To eliminate the issue we need to use resource Y that you have access to. As a result, the revised request (306-2) motivates the target user to take the desired action by crafting a primary user's request for optimal response.

FIG. 3B is an example of a request that is revised to create a revised request in summary form, according to one example of principles described herein. As will be described below, a request may be revised to create a revised request. The request may be presented to a target user in summary form.

As illustrated, the system includes a display (354-1). The display (354-1) may display a request (356-1) that is created by the primary user to another user of the social network requesting assistance with one or more steps the primary user needs to complete to achieve the goal. The request (356-1) may state, we are having issues with product X in a test environment. To eliminate the issue we need to use resource Y. In this example, the request is in English, includes the goal of eliminating issues with product X, and includes aspect step of needing to access resource Y.

As mentioned above, the motivating system may revise the request (356-1), based on a strategy, to motivate a target user to help the primary user complete the step such that the goal is achieved. As illustrated, the revised request (356-2) may be displayed via a display (354-2). In this example, the revised request (356-2) may be presented to the target user in summary form. As illustrated, the revised request (356-2) states, having issues with product X in a test environment. Your customers use product X. Eliminate the issue to reduce customer complains. Resource Y can eliminate the issues. As a result, the revised request (356-2) motivates the target user to take the desired action by crafting a primary user's request for optimal response.

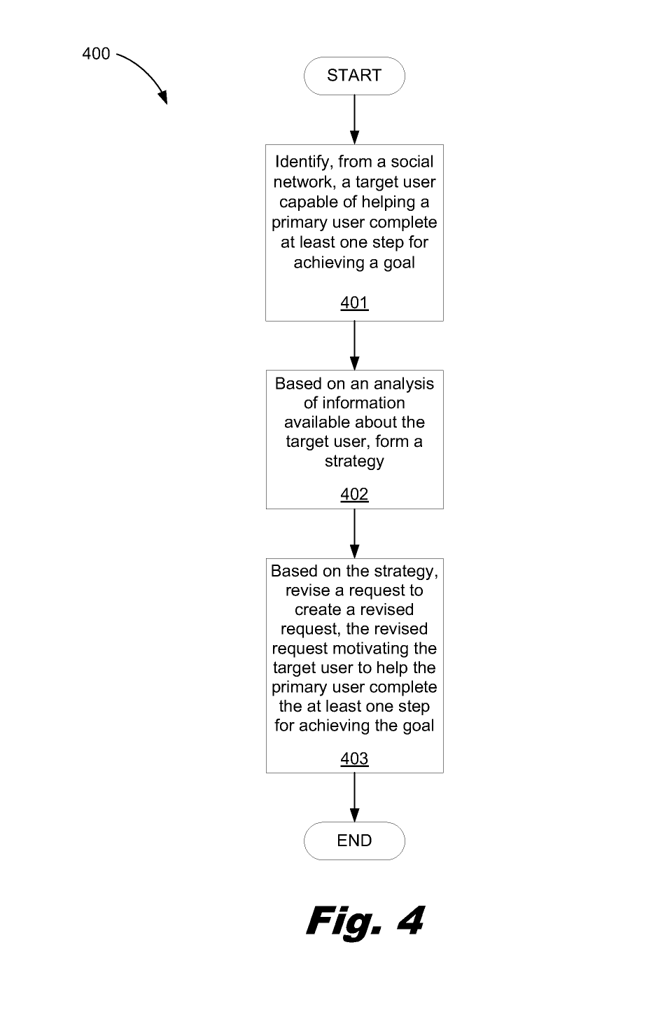

FIG. 4 is a flowchart of an example of a method for motivating a target user to aid in achieving a goal, according to one example of principles described herein. The method (400) may be executed by the system (100) of FIG. 1. The method (400) may be executed by other systems such as system 200, system 600 or system 700. In this example, the method (400) includes, identifying (401), from a social network, a target user capable of helping the primary user complete at least one step for achieving a goal, based (402) on an analysis of information available about to the target user, forming a strategy, and based (403) on the strategy, revising the request to create a revised request, the revised request motivating the target user to help the primary user complete at least one step for achieving the goal.

As mentioned above, the method (400) includes identifying (401), from a social network, a target user capable of helping the primary user complete at least one step for achieving a goal. The target user may be identified based on metadata as described above. In other examples the target user may be identified directly by the primary user. Further, the method (400) may use other methods or techniques to identify the target user.

As mentioned above, the method (400) includes, based (402) on an analysis of information about the primary user, forming a strategy. The information about the primary user may be taken from the social network or elsewhere and may include the social connections, if any, linking the primary and target users, or linking the target user to managers or others. The information about the target user may include areas of experience or expertise or resources available to the target user.

The strategy may include an analysis of how the request for assistance impacts the target user, including potential benefits to the target user from assisting with the goal of the primary user. The strategy may also include preferred methods of communication. The preferred methods of communication may include email, instant messaging, phone calls, face to face meetings, scheduled meetings, contact through a supervisor or manager, or combinations thereof.

As mentioned above, the method (400) includes based (403) on the strategy, revising the request to create a revised request, the revised request motivating the target user to help the primary user complete that step for achieving the goal. The revised request may be customized to each user that the revised request is sent to. The revised request may include wording and content specific to the role of each user. Further, the revised request may incorporate a proper chain of communication. The revised request may include cultural and language specialization. The revised request may avoid offensive or abusive language. As a result, the revised request may use common language to more effectively communicate.

In some examples, the revised request may highlight actions that help resolve an issue instead of complaining about the existence of the issue. The highlighting may include how participating in resolving the issue is in the best interest of the primary user and the target user. This may include business aspects, financial aspects, and social aspect. As a result, the revised request may include an explication of how the target user benefits by helping the primary user.

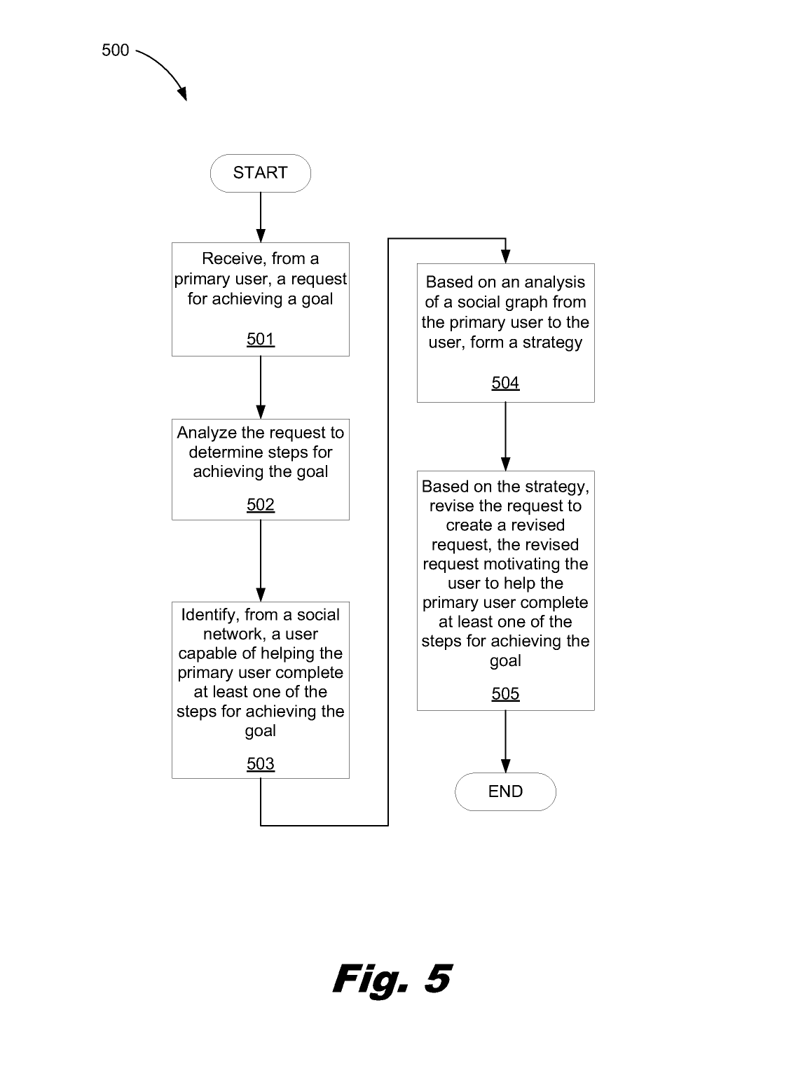

FIG. 5 is a flowchart of an example of a method for motivating a target user to aid in achieving a goal, according to one example of principles described herein. In one example, the method (500) may be executed by the system (100) of FIG. 1. In other examples, the method (500) may be executed by other systems such as system 200, system 600, or system 700. In this example, the method (500) includes receiving (501), from a primary user, a request for achieving a goal, analyzing (502) the request to determine steps for achieving the goal, identifying (503), from a social network, a target user capable of helping the primary user complete at least one step for achieving a goal, based (504) on an analysis of a social graph from the primary user to the target user, forming a strategy, and based (505) on the strategy, revising the request to create a revised request, the revised request motivating the target user to help the primary user complete that step for achieving the goal.

As mentioned above, the method (500) includes receiving (501), from a primary user, a request for achieving a goal. The request may include an explanation of the goal and steps for achieving the goal. The request may be received from a primary user via a target user device as mentioned above.

As mentioned above, the method (500) includes analyzing (502) the request to determine steps for achieving the goal. Various methods and techniques may be used to determine the steps. In some examples, the primary user may directly specify the steps in the request. The primary user may indirectly specify the steps in the request. Further, techniques such as data mining or natural language processing (NLP) may be utilized to determine the steps.

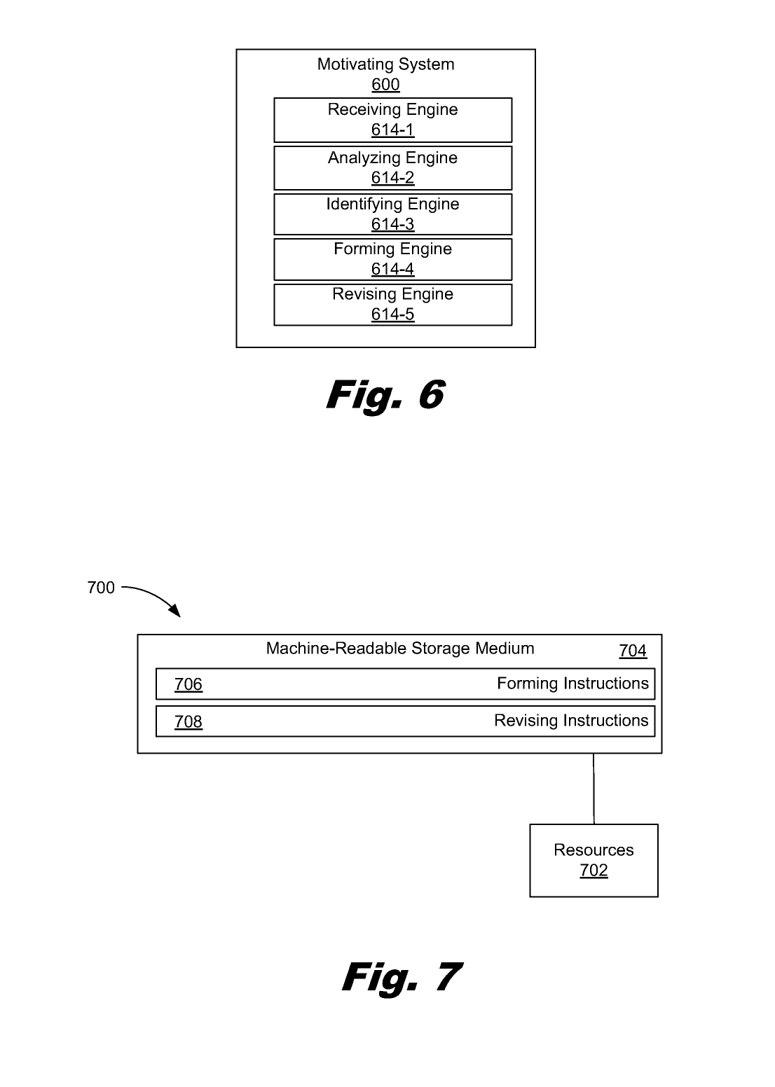

FIG. 6 is a diagram of an example of a motivating system, according to the principles described herein. The motivating system (600) includes a receiving engine (614-1), an analyzing engine (614-2), an identifying engine (614-3), a forming engine (614-4), and a revising engine (614-5). The engines (614) refer to a combination of hardware and program instructions to perform a designated function. Alternatively, the engines (614) may be implemented in the form of electronic circuitry (e.g., hardware). Each of the engines (614) may include a processor and memory. Alternatively, one processor may execute the designated function of each of the engines (614). The program instructions are stored in the memory and cause the processor to execute the designated function of the engine.

The receiving engine (614-1) receives, from a primary user, a request for achieving a goal. The receiving engine (614-1) receives, from a primary user, one request for achieving one goal. The receiving engine (614-1) receives, from a primary user, several requests for achieving several goals.

The analyzing engine (614-2) analyzes the request to determine steps for achieving the goal. The analyzing engine (614-2) analyzes the request to determine one step for achieving the goal. The analyzing engine (614-2) analyzes the request to determine several steps for achieving the goal.

The identifying engine (614-3) identifies, from a social network, a target user capable of helping the primary user complete at least one step for achieving a goal. The identifying engine (614-3) identifies, from the social network, one user capable of helping the primary user for one of the steps. The identifying engine (614-3) identifies, from the social network, several users capable of helping the primary user for several of the steps.

The forming engine (614-4) to, based on an analysis of a social graph from the primary user to the target user, form a strategy. The forming engine (614-4) forms, based on an analysis of a social graph from the primary user to the target user, one strategy. The forming engine (614-4) forms, based on an analysis of a social graph from the primary user to the target user, several strategies.

The revising engine (614-5) to, based on the strategy, revise the request to create a revised request, the revised request motivating the target user to help the primary user complete that step for achieving the goal. The revising engine (614-5) revises, based on one strategy, the request to create one revised request, the revised request motivating the target user to help the primary user complete that step for achieving the goal. The revising engine (614-5) revises, based on several strategies, the request to create several revised requests, the revised requests motivating several users to help the primary user achieve the goal.

FIG. 7 is a diagram of an example of a motivating system, according to the principles described herein. In this example, the motivating system (700) includes resource(s) (702) that are in communication with a machine-readable storage medium (704). Resource(s) (702) may include one processor. In another example, the resource(s) (702) may further include at least one processor and other resources used to process instructions. The machine-readable storage medium (704) represents generally any memory capable of storing data such as instructions or data structures used by the motivating system (700). The instructions shown stored in the machine-readable storage medium (704) and include forming instructions (706) and revising instructions (708).

The machine-readable storage medium (704) contains computer readable program code to cause tasks to be executed by the resource(s) (702). The machine-readable storage medium (704) may be tangible and/or physical storage medium. The machine-readable storage medium (704) may be any appropriate storage medium that is not a transmission storage medium. A non-exhaustive list of machine-readable storage medium types includes non-volatile memory, volatile memory, random access memory, write only memory, flash memory, electrically erasable program read only memory, or types of memory, or combinations thereof.

The forming instructions (706) represents instructions that, when executed, cause the resource(s) (702) to, based on an analysis of a social graph from a primary user to a target user, form a strategy. The revising instructions (708) represents instructions that, when executed, cause the resource(s) (702) to, based on the strategy, revise the request to create a revised request, the revised request motivating the target user to help the primary user complete at least one step for achieving a goal.

Further, the machine-readable storage medium (704) may be part of an installation package. In response to installing the installation package, the instructions of the machine-readable storage medium (704) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the resource(s) (702) and the machine-readable storage medium (704) are located within the same physical component, such as a server, or a network component. The machine-readable storage medium (704) may be part of the physical component's main memory, caches, registers, non-volatile memory, or elsewhere in the physical component's memory hierarchy. Alternatively, the machine-readable storage medium (704) may be in communication with the resource(s) (702) over a network. Further, the data structures, such as the libraries, may be accessed from a remote location over a network connection while the programmed instructions are located locally. Thus, the motivating system (700) may be implemented on a target user device, on a server, on a collection of servers, or combinations thereof.

The motivating system (700) of FIG. 7 may be part of a general purpose computer. However, in alternative examples, the motivating system (700) is part of an application specific integrated circuit.

The preceding description has been presented to illustrate and describe examples of the principles described. This description is not intended to be exhaustive or to limit these principles to any precise form disclosed. Many modifications and variations are possible in light of the above teaching.

The flowchart and block diagrams in the figures illustrate the architecture, functionality, and operations of possible implementations of systems, methods, and computer program products. In this regard, each block in the flowchart or block diagrams may represent a module, segment, or portion of code, which has a number of executable instructions for implementing the specific logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration and combination of blocks in the block diagrams and/or flowchart illustration, can be implemented by special purpose hardware-based systems that perform the specified functions or acts, or combinations of special purpose hardware and computer instructions.

The terminology used herein is for the purpose of describing particular examples, and is not intended to be limiting. As used herein, the singular forms “a,” “an” and “the” are intended to include the plural forms as well, unless the context clearly indicated otherwise. It will be further understood that the terms “comprises” and/or “comprising” when used in the specification, specify the presence of stated features, integers, operations, elements, and/or components, but do not preclude the presence or addition of a number of other features, integers, operations, elements, components, and/or groups thereof.

What is claimed is:

1. A method for motivating a target user to aid in achieving a goal, the method comprising, with a computer having a network interface and programmed to perform the method:
identifying, from a social network, a target user capable of helping a primary user complete at least one step for achieving a goal;
based on an analysis of information available about the target user, forming a strategy; and
based on the strategy, revising a request to create a revised request, the revised request motivating the target user to help the primary user complete the at least one step for achieving the goal.

2. The method of claim 1, wherein the strategy identifies how the request affects the target user, how the request benefits the target user, assets for exchange, a preferred communication, mutual benefits, or combinations thereof.

3. The method of claim 1, wherein the revised request is delivered to the target user via electronic mail (email), instant message (IM), short message service (SMS), a posting on the social network, or combinations thereof.

4. The method of claim 1, wherein the request defines the goal and the at least one step for achieving the goal.

5. The method of claim 1, wherein the strategy comprises motivating factors, the motivating factors being weighted based on an impact of an outcome of the request.

6. The method of claim 1, wherein identifying the target user comprises analyzing information about potential target users available on the social network.

7. The method of claim 1, further comprising analyzing the request to determine the at least one step for achieving the goal.

8. A system for motivating a target user to aid in achieving a goal, the system comprising:
a processor;
computer program code, communicatively coupled to the processor, the computer program code comprising;
an analyzing engine to analyze a request to determine steps for achieving a goal;
an identifying engine to identify, from a social network, a target user capable of helping a primary user complete at least one of the steps for achieving the goal;
a forming engine to, based on an analysis of a social graph of social connections including connections from the primary user to the target user, form a strategy; and
a revising engine to, based on the strategy, revise the request to create a revised request, the revised request motivating the target user to help the primary user complete that step for achieving the goal.

9. The system of claim 8, further comprising a receiving engine to receive, from the primary user, the request for achieving the goal.

10. The system of claim 8, wherein the strategy identifies how the request affects the target user, how the request benefits the target user, assets for exchange, a preferred communication, mutual benefits, or combinations thereof.

11. The system of claim 8, wherein the revised request is delivered to the target user via electronic mail (email), instant message (IM), short message service (SMS), a posting on the social network, or combinations thereof.

12. The system of claim 8, wherein the request defines the goal and the steps for achieving the goal.

13. The system of claim 8, wherein the strategy comprises motivating factors, the motivating factors being weighted based on an impact of an outcome of the request.

14. A machine-readable, non-volatile storage medium encoded with instructions, the instructions executable by a processor of a system to cause the system to:
access a social network through a network interface and obtain information about potential target users who may be able to assist a primary user with at least one step for achieving a goal of the primary user;
identify a target user that, based on information available, is able to assist the primary user with at least one step for achieving the goal;
create a social graph, the social graph illustrating connections between users of the social network and others, the social graph illustrating social connections, if any between the primary and target users;
analyze the social graph;
based on an analysis of a social graph from a primary user to a target user, form a strategy indicative of an optimal method for contacting the target user and an analysis of an impact on the target user from assisting with at least one step for achieving the goal; and
based on the strategy, revise a request to create a revised request to the target user, the revised request motivating the target user to help the primary user complete at least one step for achieving the goal.

15. The machine-readable storage medium of claim 14, further comprising instructions that, when executed, cause the processor to analyze the request to determine the at least one step for achieving the goal.

16. The machine-readable storage medium of claim 14, further comprising instructions that, when executed, cause the processor to identify information about a potential target user from at least one source outside the social network.

17. The machine-readable storage medium of claim 14, further comprising instructions that, when executed, cause the processor to transmit to the target user, from the primary user, the revised request for assistance achieving the goal.

18. The machine-readable storage medium of claim 14, wherein the strategy identifies how the request benefits the target user, assets for exchange, a preferred communication, mutual benefits, or combinations thereof.

19. The machine-readable storage medium of claim 14, wherein the strategy comprises motivating factors, the motivating factors being weighted based on an impact of an outcome of the request.

20. The machine-readable storage medium of claim 14, wherein the request defines the goal and the at least one step for achieving the goal.
